(19) United States
(12) Patent Application Publication
(10) Pub. No.: US 2023/0383508 A1
(43) Pub. Date: Nov. 30, 2023

(54) SHOWERHEAD DEVICE WITH FUNCTION OF PROVIDING CLEANSING SOLUTION

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN)

(73) Assignee: Purity (Xiamen) Sanitary Ware Co., Ltd., Xiamen City (CN)

(21) Appl. No.: 17/893,854

(22) Filed: Aug. 23, 2022

(30) Foreign Application Priority Data
May 24, 2022 (CN) 202210573448.7

(51) Int. Cl. E03C 1/046; E03C 1/04; B05B 7/04

(52) U.S. Cl. CPC E03C 1/046; E03C 1/0408; B05B 7/0408

(57) ABSTRACT

A showerhead device which could provide a cleansing solution includes a main body, a storing assembly, a guiding assembly, and a solution outlet assembly. The main body includes a showering portion and a water outlet surface located on a side of the showering portion. The storing assembly disposed on the main body includes a filling space for being filled with the cleansing solution. The guiding assembly disposed in the main body is engaged with the storing assembly and communicates with the filling space. The solution outlet assembly disposed in the main body is engaged with the guiding assembly and includes a solution outlet portion disposed on the side of the showering portion having the water outlet surface. The solution outlet assembly sucks the cleansing solution in the storing assembly via a negative pressure suction, thereby spraying out the cleansing solution through the solution outlet portion and the transferring channel.

### BACKGROUND OF THE INVENTION

### Technical Field

The present invention relates generally to a showerhead structure, and more particularly to a showerhead device which could provide a cleansing solution.

### Description of Related Art

With the improvement of the economic and social conditions, modern people start concentrating on personal living quality, wherein most people prefer traveling during holidays for relaxation.

Generally, bath sets and showering devices are usually provided in accommodations and hotels for guests to shower, but most of the guests prefer to bring their favourite shampoos and body washes, some of the guests even bring their personal showerheads, so that showering in accommodations and hotels during traveling is as comfortable as showering at home.

However, for the aforementioned guests, bringing their favourite cleansing solutions during traveling might occupy the packing space which increases the inconvenience in bringing, and the cleansing solutions might spread out during traveling, causing inconveniences during traveling.

Besides, conventional showerhead devices only could output water for showering, but could not additionally contain a cleansing solution, so that the conventional showerhead devices could not immediately provide the cleansing solution when using the conventional showerhead devices for showering, not fulfilling the requirement of modern people to shower comfortably.

Therefore, how to increase the convenience and comfort of showering during traveling, has become a major issue in the industry.

### BRIEF SUMMARY OF THE INVENTION

In view of the above, the primary objective of the present invention is to provide a showerhead device, which could output water for showering and provide a cleansing solution, increasing the convenience of showering during traveling.

The present invention provides a showerhead device which could provide a cleansing solution, including a main body, a storing assembly, a guiding assembly, and a solution outlet assembly. The main body includes a showering portion and a water outlet surface located on a side of the showering portion. The storing assembly is disposed on the main body and includes a filling space adapted to be filled with the cleansing solution. The guiding assembly is disposed in the main body and is engaged with the storing assembly, and includes a through hole and a transferring channel, wherein the through hole communicates with the filling space and the transferring channel. The solution outlet assembly is disposed in the main body and is engaged with the guiding assembly, and includes a solution outlet portion disposed on the side of the showering portion having the water outlet surface; wherein the solution outlet assembly is adapted to suck the cleansing solution in the storing assembly via a negative pressure suction, thereby spraying out the cleansing solution through the solution outlet portion by passing through the transferring channel.

With the aforementioned design, the showerhead device of the present invention could be filled with the cleansing solution, and the solution outlet portion could spray the cleansing solution on the side of the showering portion having the water outlet surface, so that the showerhead device could output water for showering and provide the cleansing solution, making showering during traveling convenient.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the showerhead device with the function of providing a cleansing solution according to an embodiment of the present invention;

FIG. 2 is a perspective view of the showerhead device according to the embodiment of the present invention seen from another direction;

FIG. 3 is an exploded view of the showerhead device according to the embodiment of the present invention;

FIG. 4 is an exploded view of the showerhead device according to the embodiment of the present invention seen from another direction;

FIG. 5 is a rear view of the showerhead device according to the embodiment of the present invention, showing the turning cover is opened;

FIG. 6 is a front view of the showerhead device according to the embodiment of the present invention;

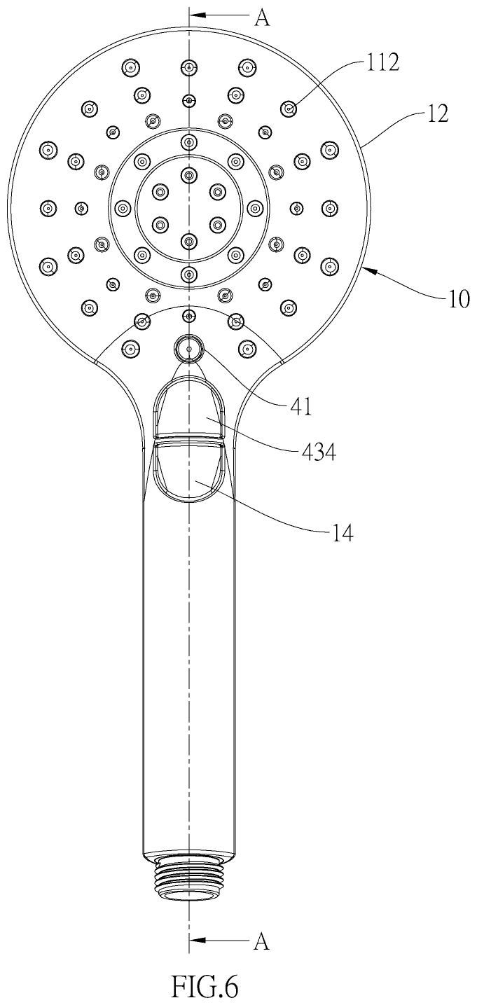

FIG. 7 is a sectional view along the A-A line in FIG. 6;

FIG. 8 is a partially enlarged view of a marked region 8 in FIG. 7;

FIG. 9 is a perspective view of the fogging nozzle of the showerhead device according to the embodiment of the present invention;

FIG. 10 is a front view of the fogging nozzle according to the embodiment of the present invention;

FIG. 11 is a rear view of the fogging nozzle according to the embodiment of the present invention;

FIG. 12 is a schematic view illustrating the flow-restricting valve according to the embodiment of the present invention is located at the first position; and

FIG. 13 is a schematic view illustrating the flow-restricting valve according to the embodiment of the present invention is moved to the second position.

### DETAILED DESCRIPTION OF THE INVENTION

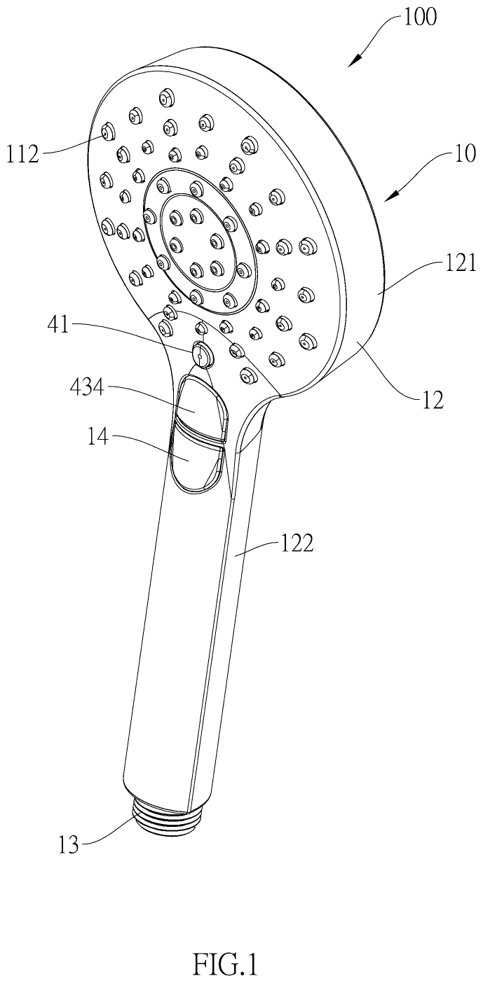

A showerhead device 100 which could provide a cleansing solution according to an embodiment of the present invention is illustrated in FIG. 1 to FIG. 4 and includes a main body 10, a storing assembly 20, a guiding assembly 30, and a solution outlet assembly 40.

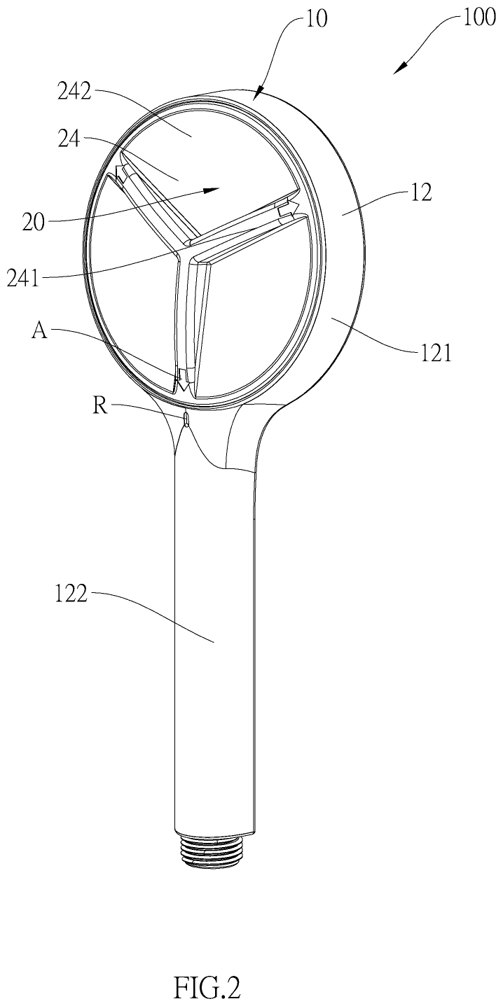

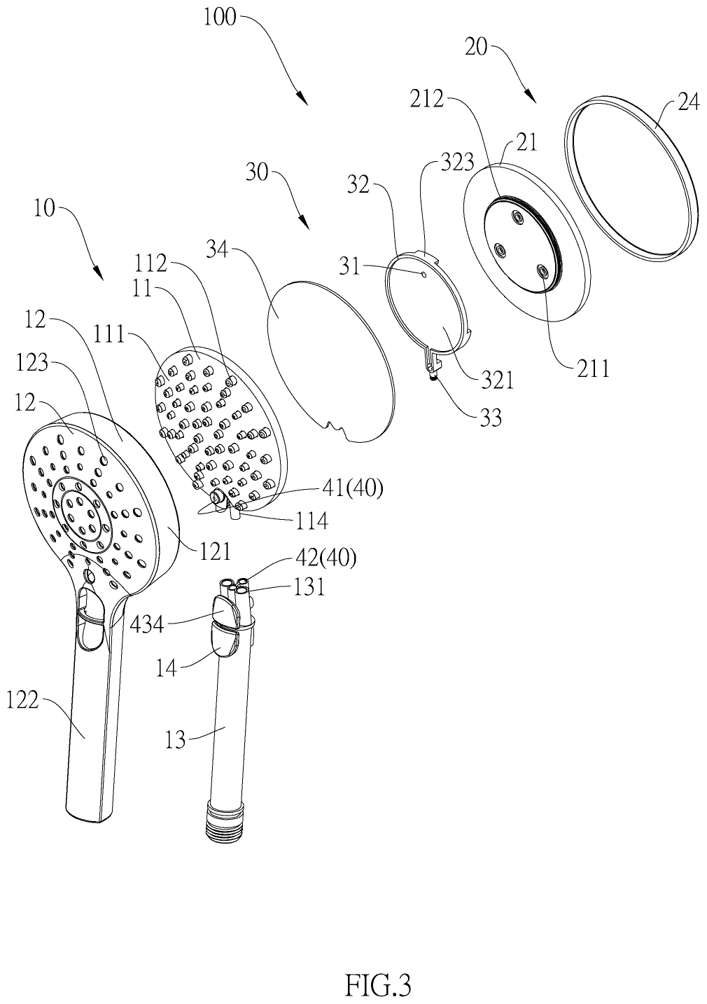

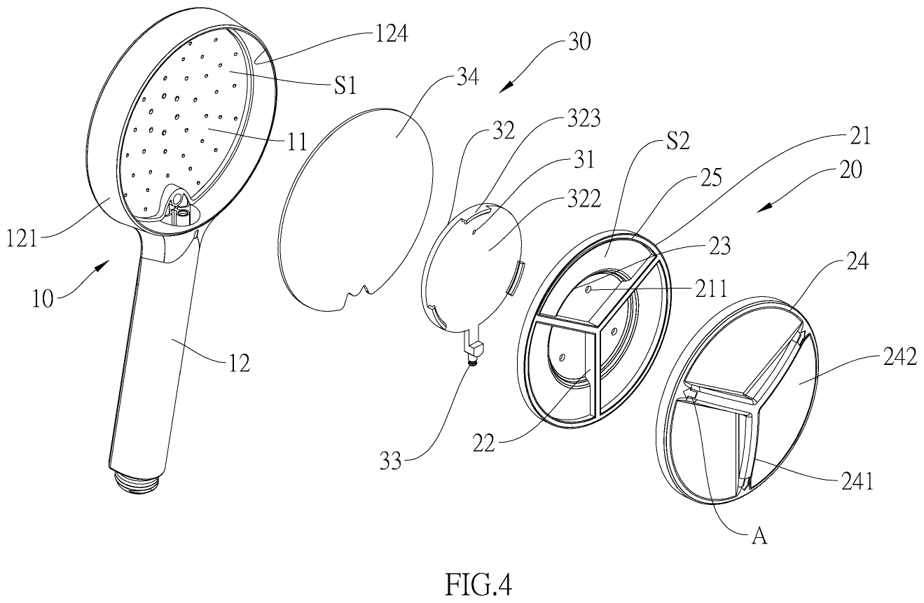

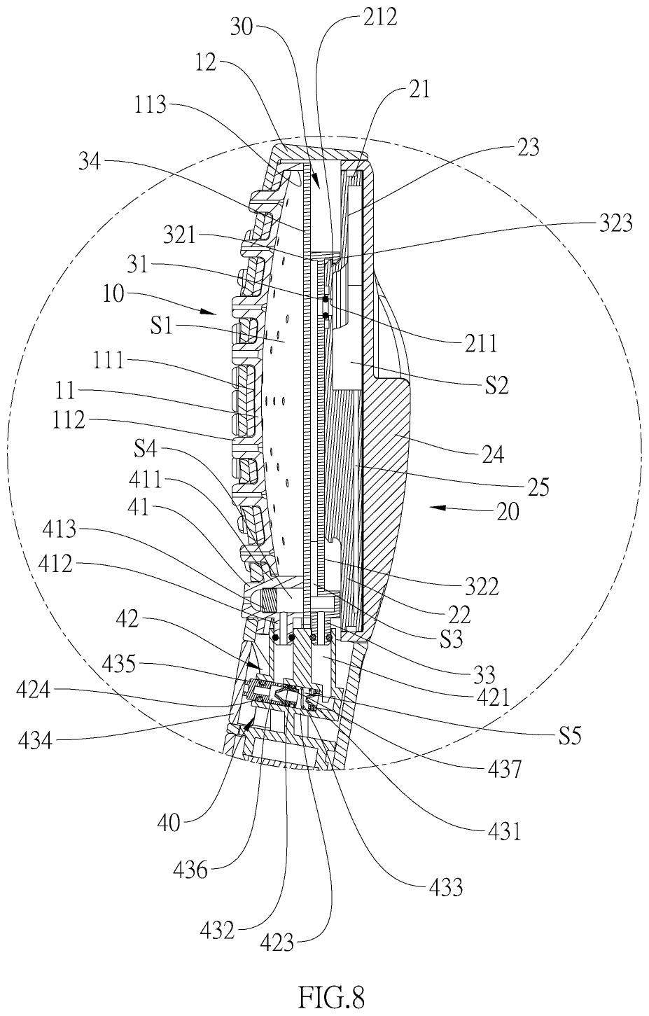

The main body 10 includes a showering portion 11 and a water outlet surface 111 located on a side of the showering portion 11, wherein a plurality of water outlet sprayheads 112 are provided on the water outlet surface 111. Referring to FIG. 3 and FIG. 4, in the current embodiment, the main body 10 includes a case 12, wherein the case 12 includes a showerhead section 121 and a holding section 122; the showerhead section 121 has a receiving space S1 therein for receiving the showering portion 11, and the holding section 122 is engaged with the showerhead section 121 for users to hold. As seen from a direction of FIG. 1 and FIG. 3, a plurality of through holes 123 is disposed on a front surface of the showerhead section 121 for the water outlet sprayheads 112 of the showering portion 11 to protrude outwards. As seen from a direction of FIG. 2 and FIG. 4, a rear surface of the showerhead section 121 has an opening 124 communicating with the receiving space S1, wherein the showering portion 11 is disposed into the receiving space S1 through the opening 124, and a side of the showering portion 11 opposite to the water outlet surface 111 has a water-accumulating groove 113 communicating with the receiving space S1 (as shown in FIG. 8).

As shown in FIG. 1 and FIG. 3, the main body 10 includes a water transmission portion 13 disposed in the holding section 122 of the case 12 and water transmission portion 13 is adapted to be engaged with a pipe externally and is connected to the showering portion 11, wherein a water outlet switch 14 is disposed on the water transmission portion 13 for users to control a water source to pass through. In the current embodiment, an end of the water transmission portion 13 facing the showerhead section 121 has two first engaging pipes 131, and the showering portion 11 has two second engaging pipes 114 extending radially outwards from a peripheral wall of the water-accumulating groove 113, wherein the two first engaging pipes 131 are correspondingly connected to the two second engaging pipes 114, so that the water transmission portion 13 could output the water source to the water-accumulating groove 113 of the showering portion 11. In other embodiments, the water outlet switch 14 could be omitted, and to control the water source by the pipe externally; the number of the first engaging pipe 131 and the number of the second engaging pipe 114 could be at least one, as long as the first engaging pipe 131 could be correspondingly connected to the second engaging pipe 114 to connect the water transmission portion 13 and the showering portion 11.

The storing assembly 20 is disposed on the main body 10 and includes a filling space S2 adapted to be filled with a cleansing solution. Referring to FIG. 3 to FIG. 5, in the current embodiment, the storing assembly 20 includes a storing container 21 disposed in the receiving space S1 of the showerhead section 121, wherein the storing container 21 has the filling space S2, and three separating blocks 22 are disposed in the filling space S2 to separate the filling space S2 into three filling grooves 23 for being respectively filled with different types of the cleansing solution, such as a shampoo, a body wash, or a face wash, and a bottom of the storing container 21 is provided with at least one solution-releasing hole 211 penetrating therethrough to respectively correspond to each of the filling grooves 23. In the current embodiment, the number of the separating block 22 is, but not limited to, three for illustration. In an embodiment, the separating block 22 could be omitted, as long as the filling space S2 could be filled with the cleansing solution. In another embodiment, the number of the separating block 22 could be one or more than one, thereby separating the filling space S2 into a plurality of filling grooves 23.

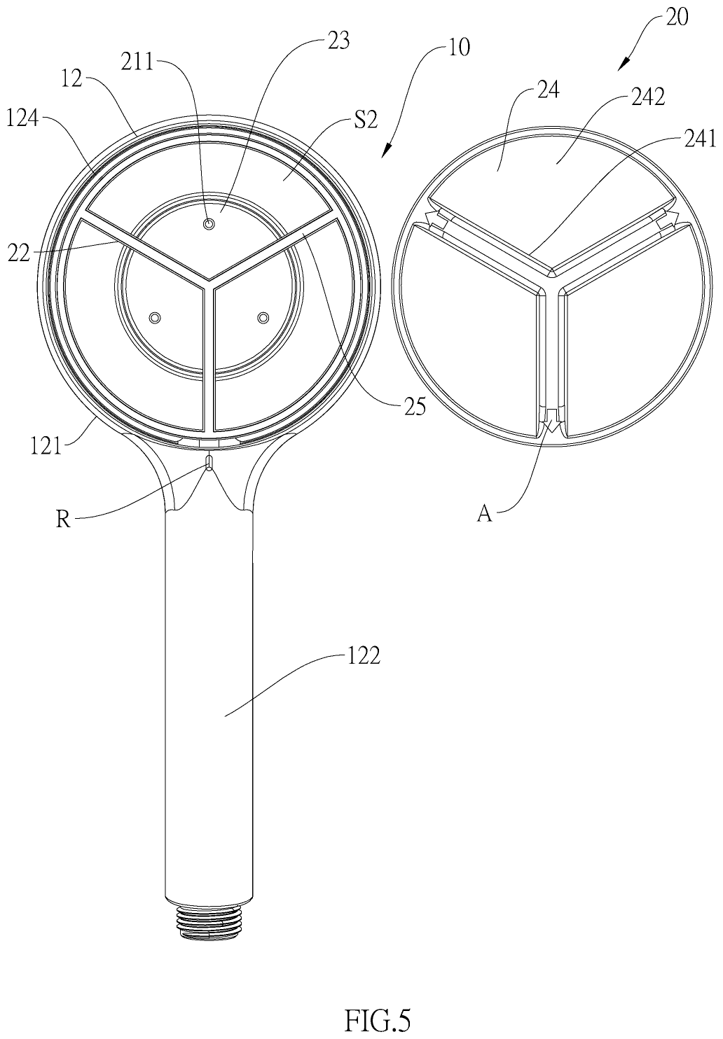

As shown in FIG. 2, FIG. 4, and FIG. 5, the storing assembly 20 includes a turning cover 24 and a sealing ring 25, wherein the turning cover 24 is disposed and covers on the storing container 21 and seals the opening 124 of the showerhead section 121, and the turning cover 24 could be operated to drive the storing container 21 to turn. In the current embodiment, a plurality of bulging blocks 241 is disposed on the turning cover 24, thereby the turning cover 24 could be turned by twisting the bulging blocks 241. An extension direction of the bulging blocks 241 is the same as an extension direction of the separating blocks 22. A label region 242 is formed between any two of the bulging blocks 241 that are adjacent, wherein a location of each of the label regions 242 corresponds to a location of one of the filling grooves 23, and the label region 242 between two of the bulging blocks 241 that are adjacent is located on an end of the other bulging block 241. The sealing ring 25 is disposed on the storing container 21, wherein when the turning cover 24 covers the storing container 21, the sealing ring 25 abuts against a bottom wall of the turning cover 24 to seal each of the filling spaces S2, so that different cleansing solutions in the storing assembly 20 would not mix together.

In other embodiments, the storing assembly 20 could be modified or replaced depending on requirements. For example, the turning cover 24 could be replaced by a typical seal cap which could seal the storing container 21; or the turning cover 24 and the sealing ring 25 could be omitted, as long as the storing container 21 could be filled with the cleansing solution in a sealed way.

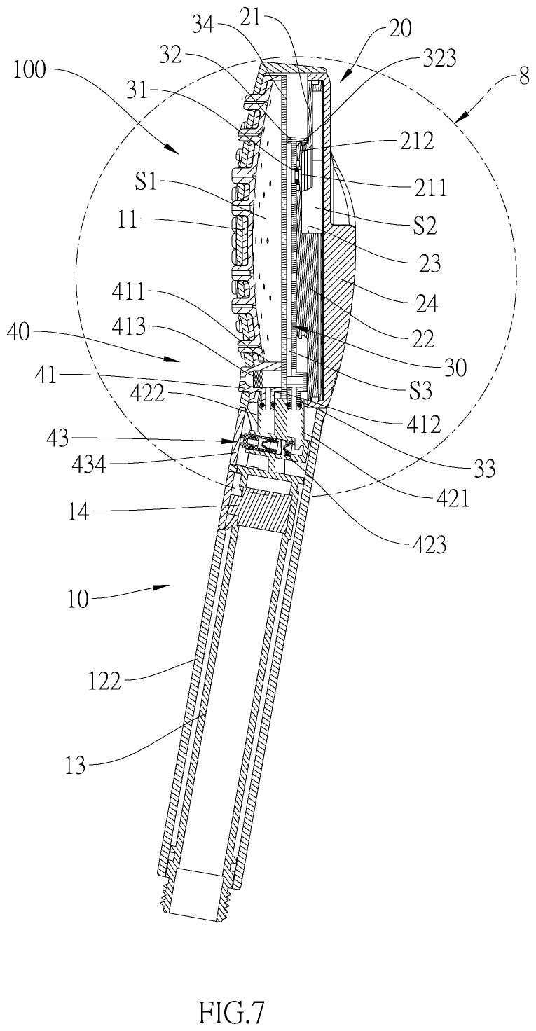

The guiding assembly 30 is disposed in the main body 10 and is engaged with the storing assembly 20 and includes a through hole 31 and a transferring channel S3, wherein the through hole 31 of the guiding assembly 30 communicates with the filling space S2 and the transferring channel S3. Referring to FIG. 3 and FIG. 7, in the current embodiment, the guiding assembly 30 includes an installing base 32, a solution outlet portion 33, and a separating plate 34, wherein the installing base 32 is disposed in the receiving space S1 of the main body 10 and is located on a side of the storing container 21 facing the water outlet surface 111 (as seen from a direction of FIG. 3, FIG. 7, and FIG. 8); a side of the installing base 32 has a solution-accumulating groove 321, and another side of the installing base 32 has an abutting surface 322, wherein the through hole 31 of the guiding assembly 30 penetrates through the abutting surface 322 and a bottom of the solution-accumulating groove 321; when the turning cover 24 is turned, the turning cover 24 drives the storing container 21 to turn relative to the installing base 32, and one of the solution-releasing hole 211 of the storing container 21 could correspond to and communicate with the through hole 31 of the guiding assembly 30, making the transferring channel S3 communicate with the corresponding filling groove 23.

Referring to FIG. 3, FIG. 4, and FIG. 7, in the current embodiment, a plurality of engaging blocks 323 is provided on the abutting surface 322, and a protruding ring 212 is provided on the side of the storing container 21 facing the water outlet surface 111. When the storing container 21 is disposed on the installing base 32, the engaging blocks 323 are engaged with a peripheral edge of the protruding ring 212, thereby positioning the storing container 21 on the abutting surface 322. The solution outlet portion 33 extends radially outwards from a side wall of the solution-accumulating groove 321, and the solution outlet portion 33 has the transferring channel S3 communicating with the solution-accumulating groove 321, so that the solution-accumulating groove 321 could communicate with the transferring channel S3 and the through hole 31 of the guiding assembly 30. The separating plate 34 seals an opening of the solution-accumulating groove 321 and an opening of the water-accumulating groove 113, and the installing base 32 is fixed on a side of the separating plate 34 opposite to the water-accumulating groove 113 of the showering portion 11, preventing the solution-accumulating groove 321 from communicating with the water-accumulating groove 113.

In other embodiments, the guiding assembly 30 could be modified or replaced depending on requirements. For example, the number of the engaging block 323 on the installing base 32 could be at least one, or the installing base 32 could be replaced by a typical engaging member; the separating plate 34 could be omitted, as long as the solution-accumulating groove 321 of the installing base 32 is designed as a sealed groove to prevent the solution-accumulating groove 321 from communicating with the water-accumulating groove 113.

Referring to FIG. 5, in the current embodiment, each of the bulging blocks 241 has an indicating arrow A pointing radially outwards, and a side of the holding section 12 opposite to the water outlet surface 111 has a reference point R. When the turning cover 24 is turned, the turning cover 24 drives the storing container 21 to turn, hence to drive the indicating arrow A on one of the bulging blocks 241 to point to the reference point R, making the label region 242 corresponding to an end of the bulging block 241 and the solution-releasing hole 211 of the filling groove 23 correspond to the through hole 31 of the guiding assembly 30, so that users could select and switch the preferred cleansing solutions precisely.

The solution outlet assembly 40 is disposed in the main body 10 and is engaged with the guiding assembly 30 and includes a solution outlet portion 41 disposed on the side of the showering portion 11 having the water outlet surface 111, thereby the solution outlet assembly 40 could guide the cleansing solution in the storing assembly 20 via a negative pressure suction to flow from the transferring channel S3 of the guiding assembly 30 to the solution outlet portion 41 to be sprayed out. Referring to FIG. 1, FIG. 3, FIG. 7, and FIG. 8, in the current embodiment, the solution outlet portion 41 has a solution outlet sprayhead 411 and a radial tube 412, wherein the solution outlet sprayhead 411 is disposed on the water outlet surface 111 of the showering portion 11 and protrudes out of one of the through holes 123 of the water outlet surface 111, so that a solution-outputting direction of the solution outlet sprayhead 411 is the same as an water-outputting direction of the water outlet sprayheads 112. The radial tube 412 extends radially outwards from a side wall of the solution outlet sprayhead 411 to the water transmission portion 13 and is located on a side of the solution outlet portion 33 facing the water outlet surface 111.

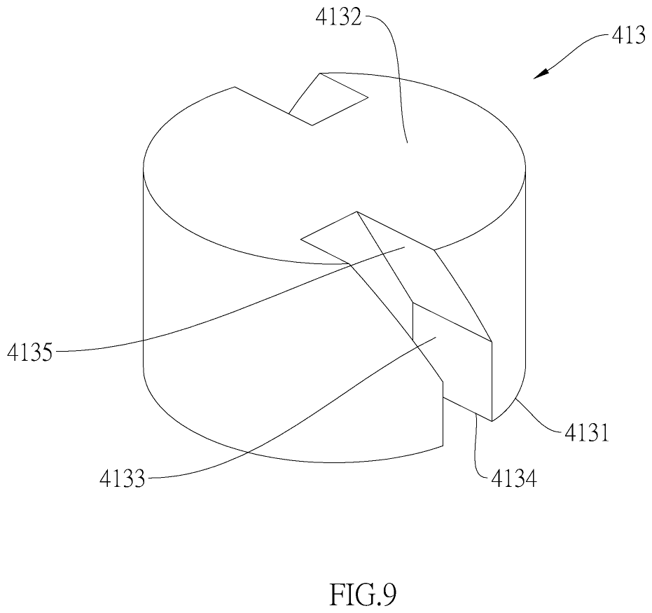

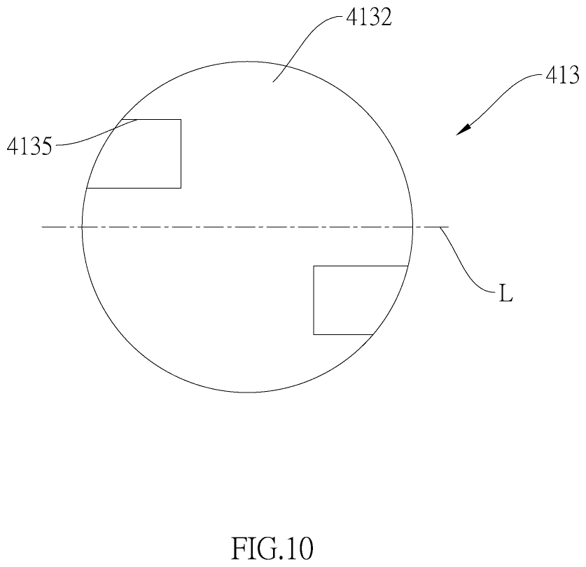

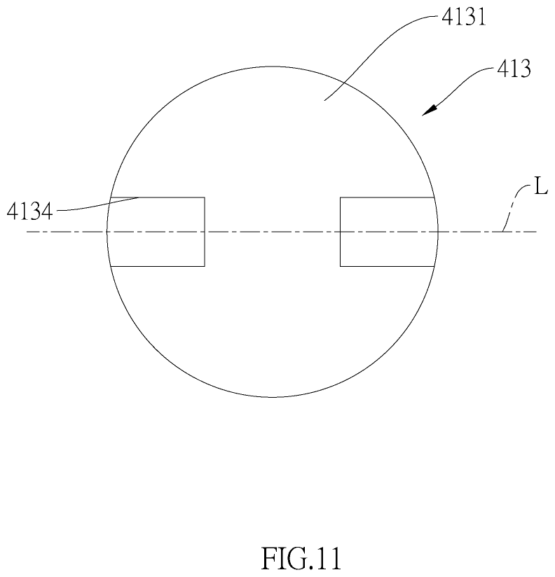

As shown in FIG. 7 and FIG. 8, an inner space S4 of the solution outlet sprayhead 411 communicates with the radial tube 412. In the current embodiment, a fogging nozzle 413 is disposed in the inner space S4 of the solution outlet sprayhead 41 and is adapted to make the cleansing solution become a plurality of droplets via the high pressure fogging. As shown in FIG. 9 to FIG. 11, two opposite sides of the fogging nozzle 413 respectively have a solution inlet surface 4131 and a solution outlet surface 4132, and the fogging nozzle 413 has two flow-restricting channels 4133 penetrating through the solution inlet surface 4131 and the solution outlet surface 4132. The two flow-restricting channels 4133 are recessed into a side wall of the fogging nozzle 413, wherein each of the flow-restricting channels 4133 has a solution inlet hole 4134 penetrating through the solution inlet surface 4131 and a solution outlet hole 4135 penetrating through the solution outlet surface 4132. A reference surface L passing through the two solution inlet holes 4134 is defined on the fogging nozzle 413, and the two solution outlet holes 4135 are respectively located on two opposite sides of the reference surface L. In other words, the two flow-restricting channels 4133 penetrate through the solution inlet surface 4131 and the solution outlet surface 4132 of the fogging nozzle 413 in a sloped way, and sloping directions of the two flow-restricting channels 4133 are opposite to each other. With the design of the fogging nozzle 413, the cleansing solution could be sprayed out through the solution outlet portion 41 when the solution outlet assembly 40 sucks the cleansing solution, wherein a pressure difference is occurred between the flow-restricting channels 4133 of the fogging nozzle 413 and the inner space S4 (i.e. a pressure inside the flow-restricting channels 4133 is less than a pressure inside the inner space S4), at that time the cleansing solution collides with a slope of the two flow-restricting channels 4133 of the fogging nozzle 413 and is guided by the slope of each of the flow-restricting channels 4133 to spray the droplets in a direction towards a spraying hole of the solution outlet sprayhead 411 in a sloped way, and due to a surface tension of the cleansing solution, the cleansing solution keep on spraying outwards in a sloped way after the cleansing solution exits the solution outlet sprayhead 411, thereby providing a cleansing spray.

In other embodiments, the solution outlet portion 41 could be modified depending on requirements. For example, the fogging nozzle 413 could be omitted, as long as the solution outlet portion 41 could spray out liquid; a direction that the radial tube 412 of the solution outlet portion 41 being disposed could be adjusted.

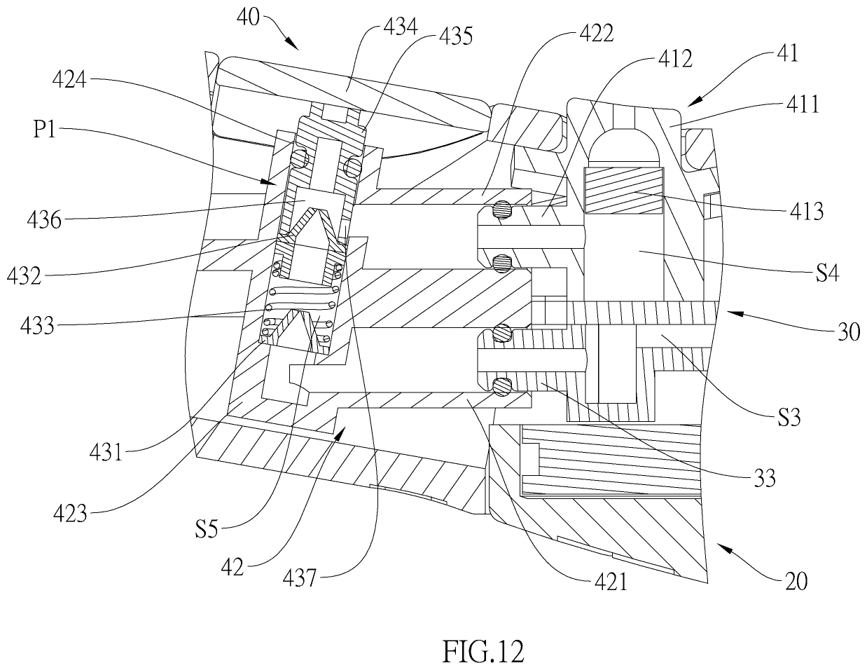

Referring to FIG. 3, FIG. 7, FIG. 8, and FIG. 12, in the current embodiment, the solution outlet assembly 40 includes a guiding portion 42 and a flow-restricting valve 43, wherein the guiding portion 42 is engaged with an end of the water transmission portion 13 and is located between the two first engaging pipes 131. The guiding portion 42 is connected to the solution outlet portion 41 to communicates with the transferring channel S3 of the solution outlet portion 33 and includes a first guiding section 421, a second guiding section 422, and a connecting section 423, wherein the first guiding section 421 communicates with the solution outlet portion 33, the second guiding section 422 communicates with the solution outlet portion 41, and the connecting section 423 communicates with the first guiding section 421 and the second guiding section 422.

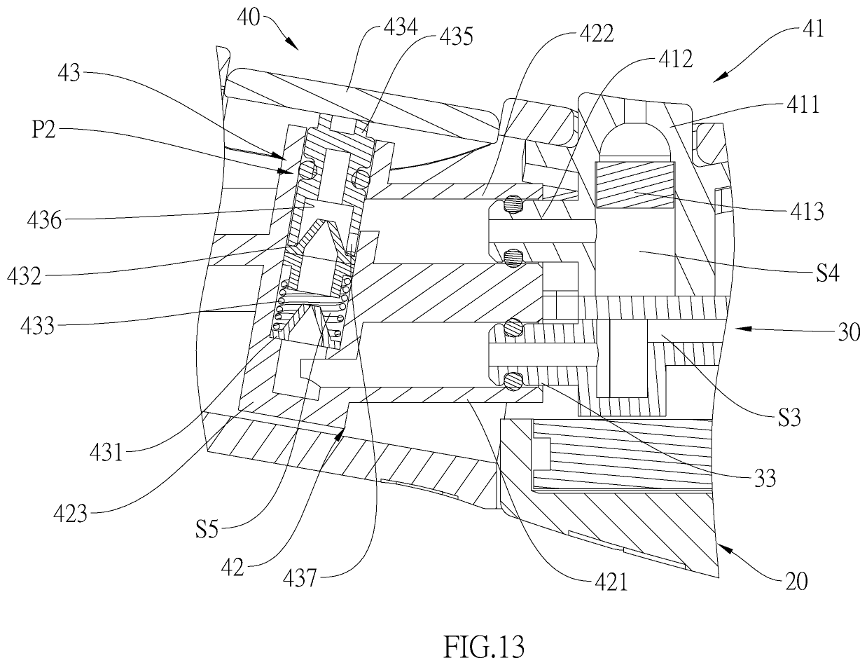

As shown in FIG. 12 and FIG. 13, the flow-restricting valve 43 is disposed in the guiding portion 42, and could move between a first position P1 and a second position P2 to allow or restrict the cleansing solution from passing through the guiding portion 42. The flow-restricting valve 43 has a fixed valve member 431, a movable valve member 432, a spring 433, a button 434, and a driven block 435, wherein the fixed valve member 431 is fixed in the connecting section 423, and is closer to the first guiding section 421 than the second guiding section 422. The movable valve member 432 could move relative to the fixed valve member 431 in the connecting section 423. Two opposite ends of the spring 433 respectively abut against the fixed valve member 431 and the movable valve member 432, such that a temporary storage space S5 is formed between the fixed valve member 431 and the movable valve member 432. The fixed valve member 431 and the movable valve member 432 are a check valve, so that the fixed valve member 431 and the movable valve member 432 could prevent the cleansing solution from flowing back to the first guiding section 421 when the cleansing solution from the first guiding section 421 passes through the connecting section 423, and a part of the cleansing solution could be stored in the temporary storage space S5.

As shown in FIG. 7, FIG. 8, and FIG. 12, the button 434 is disposed on the holding section 122, and the driven block 435 penetrates the holding section 122 and is connected to the button 434. As an end of the connecting section 423 facing the driven block 435 has a through hole 424 penetrating along a axial direction of the connecting section 423, the driven block 435 could penetrate the through hole 424 of the connecting section 423 and insert into the connecting section 423, and the driven block 435 is engaged with the movable valve member 432, wherein the driven block 435 has a receiving groove 436 for receiving the movable valve member 432, and a side wall of the receiving groove 436 has a side hole 437 communicating with the second guiding section 422.

In the current embodiment, the movable valve member 432 is normally located at the first position P1 (as shown in FIG. 12) in the connecting section 423, and the side hole 437 communicates with the second guiding section 422. In practice, the turning cover 24 could be turned first to make the indicating arrow A on one of the bulging blocks 241 to point to the reference point R of the holding section 122 for users to select the preferred cleansing solution, at that time the solution-releasing hole 211 of the corresponding filling groove 23 could communicate with the through hole 31 of the guiding assembly 30, so that the cleansing solution in the filling groove 23 flows into the solution-accumulating groove 321 and out through the solution outlet portion 33.

It is worth mentioning that referring to the FIG. 13, the negative pressure suction of the current embodiment is occurred when the button 434 is pressed, and the driven block 435 drives the movable valve member 432 to push in a direction towards the fixed valve member 431, and the movable valve member 432 compresses the spring 433, such that the movable valve member 432 moves to the second position P2, at that time the movable valve member 432 reduces a space of the temporary storage space S5 to lead to a negative pressure inside the temporary storage space S5, and the side hole 437 is covered by a wall of the connecting section 423.

Then, when stop pressing the button 434, the spring 433 pushes the movable valve member 432 in a direction opposite to the fixed valve member 431, making the movable valve member 432 restore to the first position P1, and a pressure inside the temporary storage space S5 is restored to suck the cleansing solution in the solution outlet portion 33, making the cleansing solution pass through the guiding portion 42, the fixed valve member 431, and the movable valve member 432 to be guided by the side hole 437 to pass through the solution outlet portion 41 to generate the cleaning spray, so that when users are showering, the solution outlet portion 41 could spray out the cleansing solution on the side of the showering portion 11 having the water outlet surface 111. Users could stop the water output of the showering portion 11 via the water outlet switch 14 before obtaining the cleansing solution, preventing the cleansing solution sprayed out by the solution outlet portion 41 from being diluted by the water sprayed out from the showering portion 11. In this way, the showerhead device 100 could provide functions of showering and providing cleansing solution, so that users could save the space for carrying bath sets, increasing the convenience of showering during travelling.

With the aforementioned design, the showerhead device 100 according to the current embodiment of the present invention could be filled with the cleansing solution, and the solution outlet portion 41 could spray out the cleansing solution on the same side of the water outlet surface 111 during washing hair or showering, so that the showerhead device 100 could provide functions of showering and providing cleansing solution, saving the space for carrying additional bath sets, increasing the convenience of showering during travelling.

Besides, the storing container 21 in the showerhead device 100 of the current embodiment is separated into the three filling grooves 23 for being respectively filled with different types of the cleansing solution. In practice use, users turn the turning cover 24 to drive the storing container 21 to turn relative to the installing base 32 to make one of the solution-releasing holes 211 of the storing container 21 correspond to and communicate with the through hole 31 of the guiding assembly 30, allowing the transferring channel S3 to communicate with the corresponding filling groove 23, so that users could select and switch the preferred cleansing solutions.

It must be pointed out that the embodiments described above are only some preferred embodiments of the present invention. All equivalent structures which employ the concepts disclosed in this specification and the appended claims should fall within the scope of the present invention.

What is claimed is:

1. A showerhead device with a function of providing a cleansing solution, comprising:
a main body comprising a showering portion and a water outlet surface located on a side of the showering portion;
a storing assembly disposed on the main body and comprising a filling space adapted to be filled with the cleansing solution;
a guiding assembly disposed in the main body and engaged with the storing assembly and comprising a through hole and a transferring channel, wherein the through hole communicates with the filling space and the transferring channel; and
a solution outlet assembly disposed in the main body and engaged with the guiding assembly and comprising a solution outlet portion disposed on the side of the showering portion having the water outlet surface; wherein the solution outlet assembly is adapted to suck the cleansing solution in the storing assembly via a negative pressure suction, thereby spraying out the cleansing solution through the solution outlet portion by passing through the transferring channel.

2. The showerhead device as claimed in claim 1, wherein the storing assembly comprises a storing container and a turning cover; the storing container has a plurality of separating blocks to separate the filling space into a plurality of filling grooves for being respectively filled with different types of the cleansing solution, and a plurality of solution-releasing holes is disposed on a bottom of the storing container, and each of the solution-releasing holes corresponds to one of the filling grooves, wherein one of the solution-releasing holes of the storing container correspondingly communicates with the through hole of the guiding assembly, making the transferring channel correspondingly communicate with one of the filling grooves; the turning cover is disposed and covers on the storing container; a plurality of bulging blocks is disposed on the turning cover, thereby the turning cover is adapted to be turned to drive the storing container to turn by twisting the bulging blocks; a label region is formed between any two of the bulging blocks that are adjacent, wherein a location of each of the label regions corresponds to a location of one of the filling grooves, and the label region between two of the bulging blocks that are adjacent is located on an end of another of the turning blocks.

3. The showerhead device as claimed in claim 2, wherein the main body comprises a holding section and a water transmission portion disposed in the holding section; the holding section has a reference point; each of the bulging blocks has an indicating arrow pointing outwards; when the turning cover is turned, the turning cover drives the storing container to turn, driving the indicating arrow on one of the bulging blocks to point to the reference point, making the label region corresponding to an end of one the bulging blocks and the solution-releasing hole of one of the filling grooves correspond to the through hole of the guiding assembly; the water transmission portion is adapted to be engaged with a pipe externally and is connected to the showering portion; a side of the showering portion opposite to the water outlet surface has a water-accumulating groove; an end of the water transmission portion has at least one first engaging pipe, and the showering portion has at least one second engaging pipe extending radially outwards from a peripheral wall of the water-accumulating groove, wherein the at least one first engaging pipe is connected to the at least one second engaging pipe; the main body comprises a showerhead section engaged with the holding section; a receiving space is provided inside the showerhead section for receiving the showering portion and the storing container; the showerhead section has an opening communicating with the receiving space, wherein the showering portion and the storing container are disposed into the receiving space through the opening; the turning cover covering the storing container seals the opening of the showerhead section.

4. The showerhead device as claimed in claim 2, wherein the guiding assembly comprises an installing base; a side of the installing base has a solution-accumulating groove, and another side of the installing base has an abutting surface; the through hole of the guiding assembly penetrates through the abutting surface and a bottom of the solution-accumulating groove; the storing container is disposed on the abutting surface; a solution outlet portion is provided on the installing base and extends radially outwards from a side wall of the solution-accumulating groove, wherein the solution outlet portion has the transferring channel communicating with the solution-accumulating groove; at least one engaging block is provided on the abutting surface, and a protruding ring is provided on the side of the storing container facing the water outlet surface 111; when the storing container is disposed on the installing base, the at least one engaging block is engaged with a peripheral edge of the protruding ring, thereby positioning the storing container on the abutting surface, and the turning cover drives the storing container to turn relative to the installing base when the turning cover is turned.

5. The showerhead device as claimed in claim 1, wherein a fogging nozzle is disposed in an inner space of the solution outlet portion and is adapted to make the cleansing solution become a plurality of droplets via the high pressure fogging; two opposite sides of the fogging nozzle respectively have a solution inlet surface and a solution outlet surface; the fogging nozzle has two flow-restricting channels penetrating through the solution inlet surface and the solution outlet surface; the two flow-restricting channels are respectively recessed into a side wall of the fogging nozzle, wherein each of the flow-restricting channels has a solution inlet hole penetrating through the solution inlet surface and a solution outlet hole penetrating through the solution outlet surface; a reference surface passing through the two solution inlet holes is defined on the fogging nozzle, and the two solution outlet holes are located on two opposite sides of the reference surface, wherein the two flow-restricting channels penetrates through the solution inlet surface and the solution outlet surface of the fogging nozzle in a sloped way, and sloping directions of the two flow-restricting channels are opposite to each other.

6. The showerhead device as claimed in claim 3, wherein the solution outlet assembly comprises a guiding portion engaged with the water transmission portion; the guiding portion is connected to the solution outlet portion to communicate with the transferring channel and comprises a first guiding section, a second guiding section, and a connecting section, wherein the first guiding section communicates with solution outlet portion, the second guiding section communicates with the solution outlet portion, and the connecting section communicates with the first guiding section and the second guiding section.

7. The showerhead device as claimed in claim 6, wherein the solution outlet assembly comprises a flow-restricting valve disposed in the guiding portion; the flow-restricting valve is movable between a first position and a second position, thereby allowing or restricting the cleansing solution to pass through the guiding portion.

8. The showerhead device as claimed in claim 7, wherein the flow-restricting valve has a fixed valve member, a movable valve member, and a spring; the fixed valve member is fixed in the connecting section, and is closer to the first guiding section than the second guiding section; the movable valve member is movable relative to the fixed valve member in the connecting section; two opposite ends of the spring respectively abut against the fixed valve member and the movable valve member, thereby forming a temporary storage space between the fixed valve member and the movable valve member.

9. The showerhead device as claimed in claim 8, wherein the flow-restricting valve comprises a button and a driven block; the driven block penetrates the connecting section and is engaged with the button and the movable valve member; the movable valve member is normally located at the first position in the connecting section; the negative pressure suction is occurred when the button is pressed; the driven block drives the movable valve member to push in a direction towards the fixed valve member to compress the spring when the button is pressed, thereby moving the movable valve member to the second position and generating a negative pressure in the temporary storage space; when the movable valve member restores to the first position, a pressure inside the temporary storage space is restored to suck the cleansing solution in the solution outlet portion, allowing the cleansing solution to pass through the guiding portion.
